(19) United States
(12) Patent Application Publication
(10) Pub. No.: US 2017/0320722 A1
(43) Pub. Date: Nov. 9, 2017

(54) HORSE TRAINING AID

(71) Applicant: Reinrite Equestrian Limited, Youghal, County Cork (IE)

(72) Inventor: Timothy O'KEEFFE, Killeagh, County Cork (IE)

(73) Assignee: Reinrite Equestrian Limited, Youghal, County Cork (IE)

(21) Appl. No.: 15/524,712

(22) PCT Filed: Nov. 5, 2015
(86) PCT No.: PCT/EP2015/075814

§ 371 Date: May 5, 2017

(30) Foreign Application Priority Data
Nov. 6, 2014 (EP) 14192049.6

(51) Int. Cl. B68B 1/04; A01K 15/02; B68B 1/02

(52) U.S. Cl. CPC B68B 1/04; A01K 15/02; B68B 1/02

(57) ABSTRACT

A horse training aid comprises a stem running from the girth to a location under the head. A coupling rope is trained through a lateral coupler wheel at the outer end of the stem. The overall length of the aid from the girth to the mouth bits or bridle prevents excessive lifting of the horses head, but offers insignificant resistance to turning of the head as the coupling rope slides on the wheel. With the training aid the horse is encouraged to maintain the correct head position, and this allows optimum muscle development.

### FIELD OF THE INVENTION

The invention relates to training of race and sport horses and ponies.

### PRIOR ART DISCUSSION

GB2509185 (Allin Katie) describes a balancing aid having a plate arranged to be located adjacent a horse's breast. EP2537795 (Maximilien Micropoulos) describes draw reins for a horse. The reins have a strap connected to the bit and leading through two crossing points on the saddle and a girth of the saddle. FR2778906 (Laurent Morali) describes a set or reins for lunging.

In general, there have been many different arrangements of reins to assist with horse training for activities such as lunging, where the horse walks or trots in a circle, for example in an arena. However, there is a problem with training of horses for racing or in a situation where they are cantering or galloping at speed and need to have the ability to turn left and right with good visibility. In such situations, current training aids can impair speed performance and/or reduce safety.

The invention addresses this problem.

### SUMMARY OF THE INVENTION

According to the invention, there is provided a horse training aid comprising:
a stem having an inner end arranged to be anchored to an element on a horse's body and to extend forwardly to a position under a horse's head or neck, and
a lateral coupler comprising an elongate member extending laterally across the stem at an outer end of the stem, and being arranged to engage at each end a horse's bridle or other element on the head, and
a lateral coupler guide on the stem at the outer end of the stem, said guide allowing the lateral coupler to run laterally across the stem to allow turning of a horse's head while the aid restrains upward movement of the head to a limit imposed by combined longitudinal length of the stem and the coupler.

In one embodiment, the stem is arranged to be anchored at the inner end to a girth.

In one embodiment, the lateral coupler elongate member comprises a rope, belt or chain. In one embodiment, the lateral coupler guide comprises a wheel on which the elongate member runs. In one embodiment, the guide comprises an upper protective cover. In one embodiment, the protective cover comprises a flap of a material such as leather or a synthetic material.

In one embodiment, the stem comprises an elasticated rope. Preferably, the lateral coupler elongate member comprises an elasticated rope. In one embodiment, the stem comprises at its inner end a quick-release fastener.

In one embodiment, the stem comprises an outer section of elasticated rope and an inner section of leather or synthetic plastics material. In one embodiment, the stem comprises at the inner end a loop of a belt material for engaging a girth.

Preferably, the loop is arranged to remain on a girth, and the stem comprises a releasable fastener for connection to the loop. In one embodiment, the stem is of adjustable length.

In one embodiment, the stem has a belt and a buckle to provide the length adjustment by way of forming a loop of desired size.

In one embodiment, the lateral coupler comprises fasteners arranged to engage a bridle mouth bit ring.

Preferably, the aid further comprises a head piece arranged to extend around a horse's head. The head piece may comprise fastener parts to engage at each of the ends of the head piece the lateral coupler. Alternatively, the head piece may be a continuation of the lateral coupler, in which case there is preferably a buckle or other fastener along the length of the head piece.

In one embodiment, the head piece is configured to extend through bridle mouth bit rings.

In one embodiment, the head piece fastener parts comprise a ring at each end for engagement with the lateral coupler.

In one embodiment, the training aid further comprises a bridle.

In another aspect, the invention provides a method of training a horse using an aid as defined above in any embodiment, the method comprising the steps of connecting the stem at its inner end to a girth, connecting the ends of the coupler to opposite side of the horse's head, setting length of the stem to provide a desired overall length of the stem and the lateral coupler to set a limit on upward movement of the horse's head.

Additional Statements

According to the invention there is provided a horse training aid comprising a primary member arranged to be centrally located under a horse's neck, and a coupling member arranged to couple at each end to a horse's mouth bit or bridle and to move laterally relative to the primary member through a lateral coupler in a manner providing little resistance to turning of a horse's head, but the primary and coupling members together providing resistance to upward movement of the horse's head.

In one embodiment, the primary member is in the form of a stem arranged to connect at an inner end to a girth and at its outer end to the lateral coupler, the connection to the girth providing an anchor for the aid.

In one embodiment, the primary member is arranged to extend from a girth between a horse's front legs and the lateral coupler.

In one embodiment, the coupling member comprises a rope or chain arranged to slide through the lateral coupler. Preferably, the lateral coupler comprises a wheel on which the coupling member runs.

In one embodiment, the primary member comprises a protective cover over the lateral coupler to prevent direct contact of the lateral coupler with a horse. In one embodiment, the protective cover comprises a flap of a material such as leather or a synthetic material.

In one embodiment, the primary member comprises an elasticated rope, which may be of a synthetic material. In one embodiment, the coupling member comprises an elasticated rope, which may be of a synthetic material.

In one embodiment, the primary member has at its inner end a quick-release fastener. Preferably, the primary member comprises an outer section of elasticated rope and an inner section of leather or synthetic plastics material.

In one embodiment, the primary member comprises a loop of a belt material for engaging a girth.

In one embodiment, the loop is arranged to remain on a girth, and the primary member has a releasable fastener for connection to the loop. In one embodiment, the primary member is of adjustable length.

In one embodiment, the primary member has a belt and a buckle to provide the length adjustment by way of forming a loop of desired size.

### DETAILED DESCRIPTION OF THE INVENTION

### Brief Description of the Drawings

The invention will be more clearly understood from the following description of some embodiments thereof, given by way of example only with reference to the accompanying drawings in which:—

FIG. 1(a) is a plan view of a horse training aid of the invention, and FIG. 1(b) is a view from the other side showing a pulley wheel which normally in use faces downwardly;

FIG. 2 is a side view of the aid in use;

FIG. 3 is a front perspective view of the aid in use;

FIG. 4 is a side view of an alternative training aid of the invention in use; and

FIG. 5 is a view from under a horse's head of this alternative training aid in use.

### DESCRIPTION OF THE EMBODIMENTS

Referring to the drawings, a training aid 1 of the invention comprises a stem 2, and an elasticated lateral bridle-coupling rope 3. The coupling rope 3 runs on a guide allowing smooth lateral movement with little resistance. In this case the guide comprises a pulley wheel 4 at an outer end of the stem 2. The pulley wheel has a groove sized to accommodate the rope 3. A the lateral coupling rope 3 runs on the pulley wheel it is free to easily move laterally with respect to the stem 2.

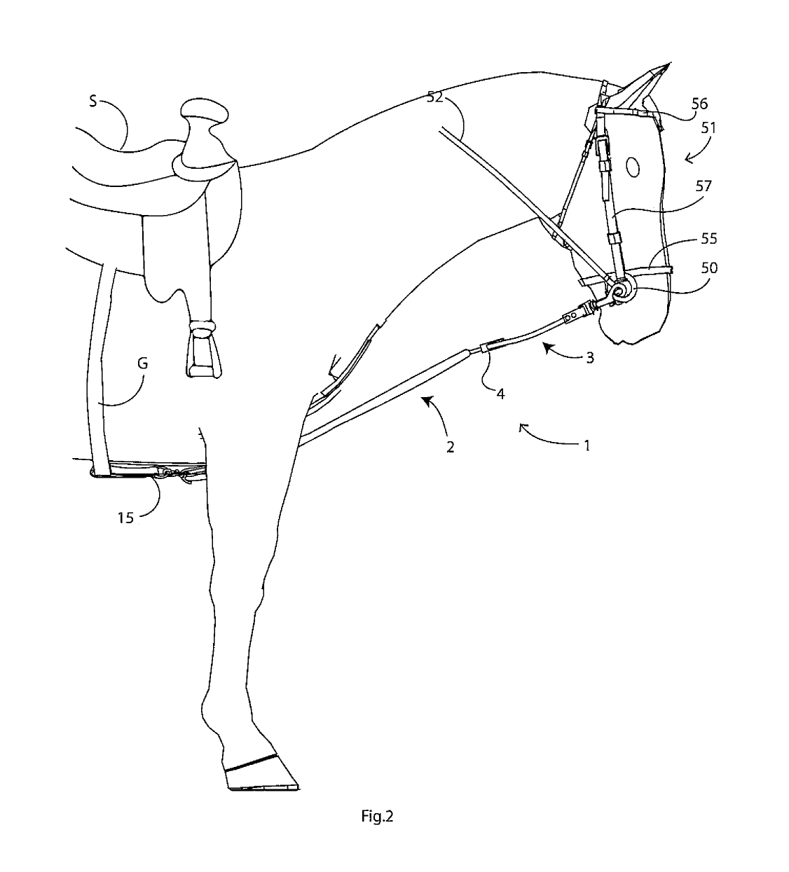

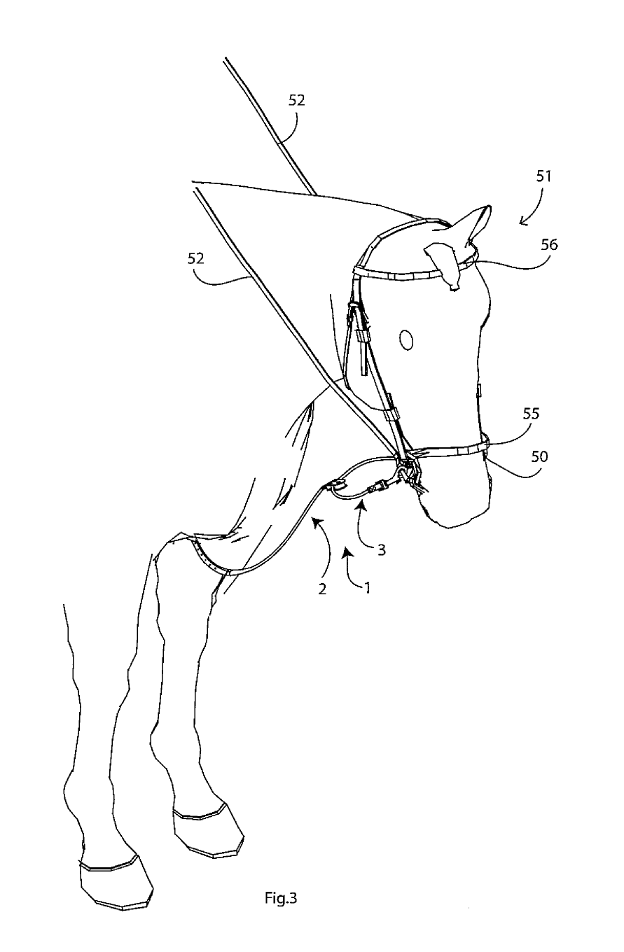

The ends of the coupling rope 3 have spring-loaded catches 5 and 6 with a swivel capability. The catches 5 and 6 connect to the mouth bit rings 50 of a conventional bridle 51. Conventional reins 52 are also attached to the rings 50. As shown in FIGS. 2 and 3 the bridle 51 also has a nose band 55, a brow band 56, and a head strap 57.

The training aid 1 and the (conventional) reins 52 all connect to the horse's head at the bridle mouth bit rings 50.

The wheel 4 is mounted on a wheel support 8 which is connected to the stem 2 at its outer end. The pulley wheel 4 is covered on its upper side by a leather flap 7, preventing the wheel 4 from coming into contact with the horse's neck. This prevents the horse's hair or skin from being entangled or injured or there being any discomfort for the horse. This cover also helps to prevent dirt from accessing the wheel 4. Such a flap or cover may be mounted underneath the wheel also.

The stem 2 has an elasticated rope section 10, connected at its inner end to a belt 11 having a buckle 12 to allow length adjustment by forming a loop 13 of a desired length. There is a swivel catch 14 linking the loop 13 with a fixed loop 15 which is fixed in size and is also of leather strap material. The catch 14 advantageously provides easy connection and disconnection from the girth G, and allows rotation of the belt without twisting. The aid may alternatively be connected to the girth G by running the girth G through the loop 13. In this case the loop 15 may be dispensed with.

As shown in FIGS. 2 and 3 the aid 1 is connected with the loop 15 around the (conventional) girth strap G under the saddle S between the horse's forelegs, and the fasteners 5 and 6 are connected to the left and right mouth bit rings 50 respectively. It will be appreciated that the training aid of the invention involves very little equipment and is very simple and fast to connect in place.

The length of the combined stem 2 and the extent of the coupling rope 3 in the longitudinal direction restrict upward movement of the horse's head while being exercised. This length may be set by adjustment of the loop 13. It is of course variable in use because of the elasticated section 10. The elasticity may be chosen to suit the particular target use.

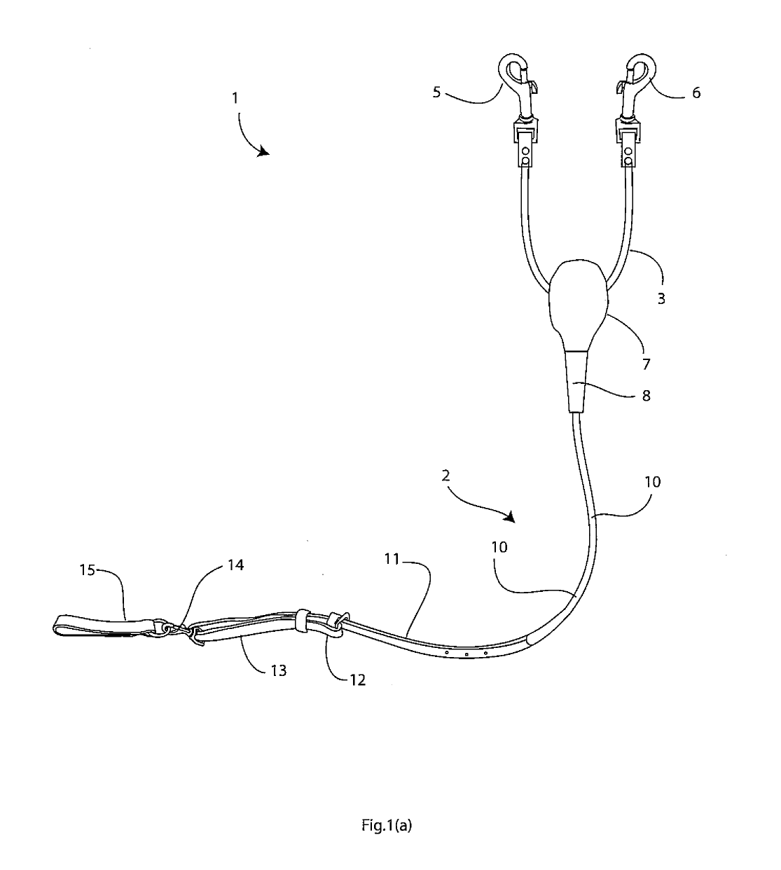

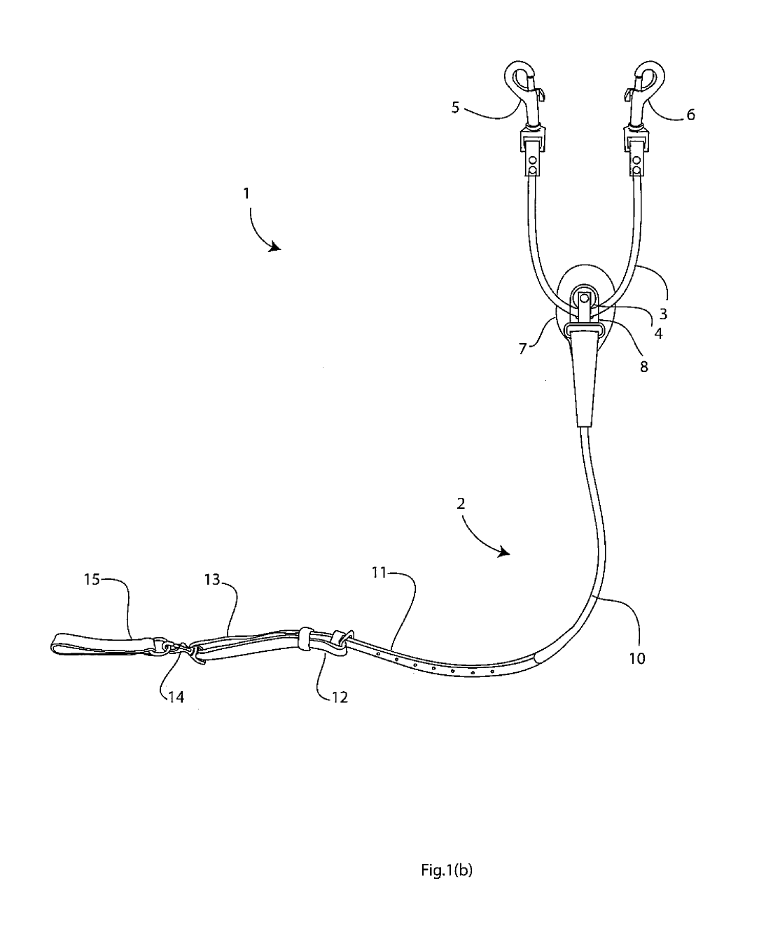

Control of upward movement of the horse's head is achieved automatically, without need for the rider to do anything. If the rider pulls on one of the reins for turning, for example right, the coupling rope 3 is pulled to the left without offering resistance to this head movement. This is simply due to the longer distance between the left side mouth bit 50 and the pulley wheel 4 as the head turns right. Of course, the opposite happens if the left-hand rein is pulled. The coupling rope 3 moves through the guide provided by the wheel 4 with very little resistance. This is achieved even though the rope 3 has the configuration of an apex at the wheel, having a sharp acute angle bend. This is best viewed in FIG. 1(b), with the additional aspect of the rope being pulled taut (it is relaxed in the before-use view of the drawing). Even if the pulley wheel 4 ceases to rotate due for example to dirt in its axle, the rope 3 would still be free to slide through due to the low-friction plastics material of the wheel.

The avoidance of resistance to rotation of the horse's head is also contributed to by the fact that the stem 2 can rotate about a vertical axis at its inner end on the girth. The outer end at the guide 4/8 is free to move laterally in an arc about a vertical axis through the coupler 14 or the loop 15 on the girth G.

Importantly, the aid 1 provides significant resistance to upward movement of the horses head, but no resistance to left and right turning movements. Hence, it advantageously trains the horse not to raise his head beyond a certain level, without affecting steering or any other aspect of the horse's movement.

With the training aid 1 the horse is encouraged to maintain the correct head position, and this allows optimum muscle development for show jumping and dressage, however, it is particularly beneficial for high speed racing.

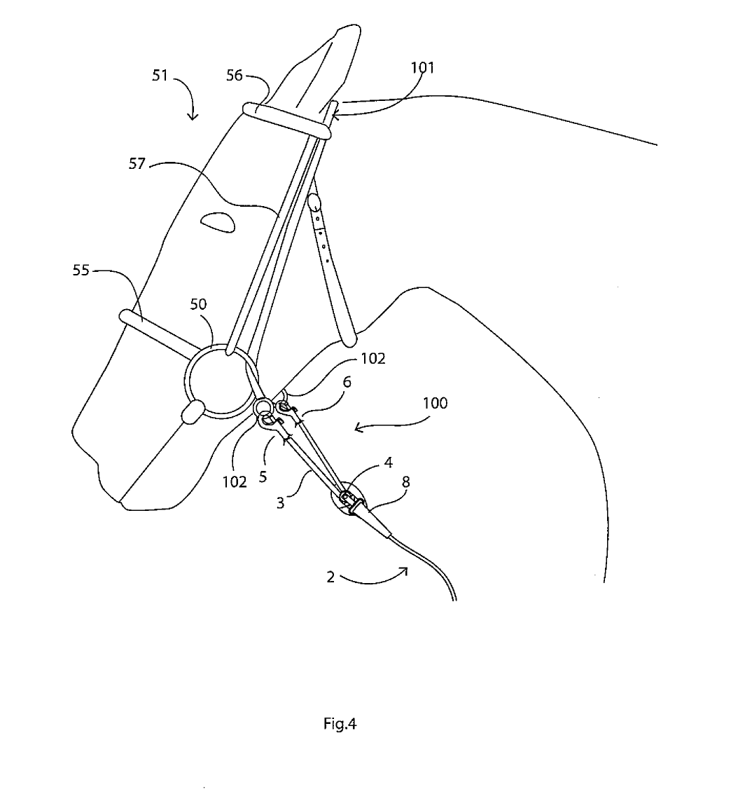

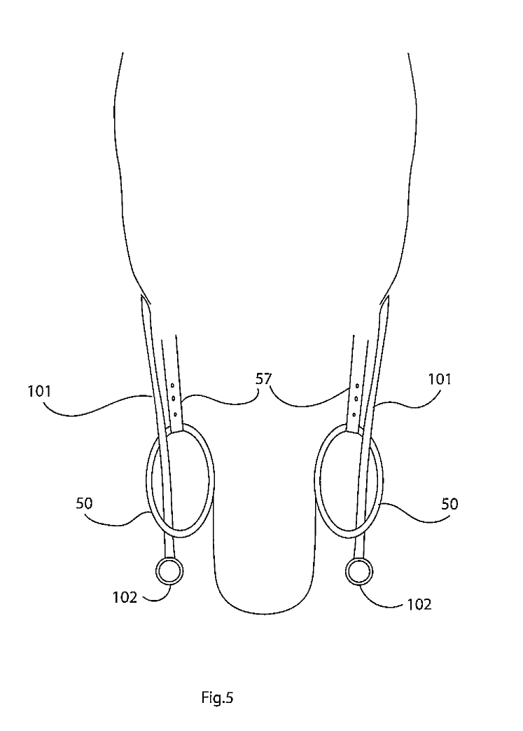

Referring to FIGS. 4 and 5 a training aid 100 of another embodiment is illustrated in use. The aid 100 has all of the components of the aid 1. However it additionally comprises a head strap 101 terminating in a ring 102 at each end. The head strap 101 is configured to extend through a bit ring 50, up along a side of the head, over the top of the head, and down the other side of the head and through the other bit ring 50. At the top of the head the head strap 101 is retained in place by being trained through the bridle brow piece 56.

Instead of the coupling rope 3 couplers 5 and 6 directly engaging the bit rings. They engage the head strap rings 102, and the head strap 101 runs through the bit rings 102. The head strap 101 follows the line of the bridle, behind the ears with a buckle for adjustment on the horse's cheek. The couplers 5 and 6 can be clipped to the head strap rings 101 or the bit.

In use, there is a degree of freedom of movement of the head strap 101 through the bit rings 50 as the horse's head moves left and right. As for the training aid 1, the aid 100 prevents the head from rising beyond the limit allowed by the chosen length of the stem 2. In this case the restraining action is mainly on the top of the horse's head rather than on the bridle bit. This is advantageous because, in use, the reins act on the bridle bit for left and right head turning, while the training aid 100 acts on the whole of the head for upward movement restraint.

The use of the head strap 101 will suit some horses that work better with additional pressure on the head as opposed to the bit. It transfers pressure or stress from the bit to the head. This will suit some horses and riders better. The strap 101 can be made of leather, or any other strong natural and man-made materials.

In various embodiments, the training aid can be used with or without this head strap, can be made of a longer elastic section and can be made of various gauge elastic sections. The elastic sections can be made from any material with elastic properties.

The invention is not limited to the embodiments described but may be varied in construction and detail. For example, the coupling rope need not necessarily be elastic. Indeed the stem need not have an elastic section either, although it is more advantageous for the stem to be elasticated. Also, it is not essential that the coupling rope runs on a wheel. It could alternatively run through a low-friction guide such as a sleeve of low-friction plastics material, preferably splayed out at its ends. Also, the aid may not have a single-stranded stem, but rather a pair of ropes which are connected to each side of the horse, and meet at an apex at or inwardly from the guide with the coupling rope. It is however, preferable that the stem has a single elongate configuration connected between the horse's forelegs, especially due to the degree of freedom of movement about a vertical axis in use.

The invention may be used with any type of horse or pony or like animal.

Also, all components of the aid may be made from leather material or any man-made material which has the necessary strength and flexibility. Also, depending on the configuration of the guide wheel, there may not be a need for a protective cover. Further, the lateral coupler may be connected to an element on the horse's head other than a bridle, such as a fastener attached for the specific purpose of engaging the lateral coupler.

1. A horse training aid comprising:
a stem having an inner end arranged to be anchored to an element on a horse's body and to extend forwardly to a position under a horse's head or neck,
a lateral coupler comprising an elongate member extending laterally across the stem at an outer end of the stem, and being arranged to engage at each end a horse's bridle or other element on the head, and
a lateral coupler guide on the stem at the outer end of the stem, said guide allowing the lateral coupler to run laterally across the stem to allow turning of a horse's head while the aid restrains upward movement of the head to a limit imposed by combined longitudinal length of the stem and the coupler.

2. A horse training aid as claimed in claim 1, wherein the stem is arranged to be anchored at the inner end to a girth.

3. A horse training aid as claimed in claim 1, wherein the lateral coupler elongate member comprises a rope, belt, or chain.

4. A horse training aid as claimed in claim 1, wherein the lateral coupler elongate member comprises an elasticated rope.

5. A horse training aid as claimed in claim 1, wherein the lateral coupler guide comprises a wheel on which the elongate member runs.

6. A horse training aid as claimed in claim 1, wherein the guide comprises an upper protective cover.

7. A horse training aid as claimed in claim 1, wherein the guide comprises an upper protective cover; and wherein the protective cover comprises a flap of a material such as leather or a synthetic material.

8. A horse training aid as claimed in claim 1, wherein the stem comprises an elasticated rope.

9. A horse training aid as claimed in claim 1, wherein the stem comprises at its inner end a quick-release fastener.

10. A horse training aid as claimed in claim 1, wherein the stem comprises at its inner end a quick-release fastener; and wherein the stem comprises an outer section of elasticated rope and an inner section of leather or synthetic plastics material.

11. A horse training aid as claimed in claim 1, wherein the stem comprises at the inner end a loop of a belt material for engaging a girth.

12. A horse training aid as claimed in claim 1, wherein the stem comprises at the inner end a loop of a belt material for engaging a girth; and wherein the loop is arranged to remain on a girth, and the stem comprises a releasable fastener for connection to the loop.

13. A horse training aid as claimed in claim 1, wherein the stem is of adjustable length.

14. A horse training aid as claimed in claim 1, wherein the stem is of adjustable length; and wherein the stem has a belt and a buckle to provide the length adjustment by way of forming a loop of desired size.

15. A horse training aid as claimed in claim 1, wherein the lateral coupler comprises fasteners arranged to engage a bridle mouth bit ring.

16. A horse training aid as claimed in claim 1, wherein the aid further comprises a head piece arranged to extend around a horse's head; and the head piece comprises fastener parts to engage the lateral coupler.

17. (canceled)

18. A horse training aid as claimed in claim 1, wherein the aid further comprises a head piece arranged to extend around a horse's head; and the head piece comprises fastener parts to engage the lateral coupler; and wherein the head piece is configured to extend through bridle mouth bit rings.

19. A horse training aid as claimed in claim 1, wherein the aid further comprises a head piece arranged to extend around a horse's head; and the head piece comprises fastener parts to engage the lateral coupler; and wherein the head piece fastener parts comprise a ring at each end for engagement with the lateral coupler.

20. A horse training aid as claimed in claim 1, further comprising a bridle, and the lateral coupler is arranged to engage at each end with the bridle.

21. A method of training a horse using an aid of claim 1, comprising the steps of connecting the stem at its inner end to a girth, connecting the ends of the coupler to opposite side of the horse's head, setting length of the stem to provide a desired overall length of the stem and the lateral coupler to set a limit on upward movement of the horse's head.
